(19) United States
(12) Patent Application Publication
(10) Pub. No.: US 2019/0294921 A1
(43) Pub. Date: Sep. 26, 2019

(54) FIELD IDENTIFICATION IN AN IMAGE USING ARTIFICIAL INTELLIGENCE

(71) Applicant: ABBYY Production LLC, Moscow (RU)

(72) Inventor: Maksim Petrovich Kalenkov, Naberezhnye Chelny (RU)

(21) Appl. No.: 15/939,004

(22) Filed: Mar. 28, 2018

(30) Foreign Application Priority Data
Mar. 23, 2018 (RU) 2018110380

(51) Int. Cl. G06K 9/62; G06K 9/00; G06N 5/04

(52) U.S. Cl. CPC G06K 9/6232; G06N 5/046; G06K 9/00456; G06K 9/00463

(57) ABSTRACT

A text field identification engine receives one or more hypotheses for a field type of a first field of text present in an image of a document and generates a three dimensional feature matrix representing a portion of the image comprising the first field. The text field identification engine provides the three dimensional feature matrix as an input to a trained machine learning model and obtains an output of the trained machine learning model, wherein the output comprises an assessment of a quality of the one or more hypotheses.

### RELATED APPLICATIONS

This application claims priority to Russian Patent Application No.: 2018110380, filed Mar. 23, 2018, the entire contents of which are hereby incorporated by reference herein.

### TECHNICAL FIELD

The present disclosure is generally related to computer systems, and is more specifically related to systems and methods for identification of text fields based on context using artificial intelligence, including convolutional neural networks.

### BACKGROUND

Information extraction may involve analyzing a natural language text to recognize and classify information objects in accordance with a pre-defined set of categories (such as names of persons, organizations, locations, expressions of times, quantities, monetary values, percentages, etc.). Information extraction may further identify relationships between the recognized named entities and/or other information objects.

### SUMMARY OF THE DISCLOSURE

In one embodiment, a text field identification engine receives one or more hypotheses for a field type of a first field of text present in an image of a document. In one embodiment, the text field identification engine processes the image to generate a three dimensional feature matrix representing a portion of the image comprising the first field. To do so, the text field identification engine may identify a plurality of horizontal lines of text present in the image, wherein one of the plurality of horizontal lines includes the first field, define a coordinate system for the plurality of horizontal lines, and shift the coordinate system horizontally based on a location of the first field in the image to form a shifted coordinate system, wherein the three dimensional feature matrix is based on the shifted coordinate system. To define the coordinate system, the text field identification engine may identify a left edge and a right edge of the document in the image, associate a first value with a first location at an intersection of the left edge and at least one of the plurality of horizontal lines, and associate a second value with a second location at an intersection of the right edge and the at least one of the plurality of horizontal lines. To shift the coordinate system horizontally, the text field identification engine may shift the first value to the location of the first field in the image.

In one embodiment, the text field identification engine further crops the image to form a cropped image comprising a set number of lines above and below the one of the plurality of horizontal lines that includes the first field, divides the cropped image into a plurality of cells, and calculates a plurality of features for each of the plurality of cells, wherein the plurality of features comprises information related to graphic elements representing one or more characters present in a corresponding cell and comprises at least one component of the three dimensional feature matrix.

In one embodiment, the text field identification engine provides the three dimensional feature matrix as an input to a trained machine learning model and obtains an output of the trained machine learning model. The trained machine learning model may include, for example, a convolutional neural network. The output of the trained machine learning model comprises an assessment of a quality of the one or more hypotheses. This assessment comprises at least one of an indication that a first hypothesis of the one or more hypotheses is a preferred hypothesis from a plurality of hypotheses or a confidence value associated with the one or more hypotheses. In one embodiment, the trained machine learning model is trained using a training data set comprising examples of images of documents comprising one or more fields as a training input and one or more field type identifiers that correctly correspond to the one or more fields as a target output.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an illustrative system architecture, in accordance with one or more aspects of the present disclosure.

FIGS. 2A and 2B depict a document image having a number of fie identified in accordance with one or more aspects of the present disclosure.

FIG. 3 is a flow diagram illustrating a field identification method, in accordance with one or more aspects of the present disclosure.

FIG. 4 is a flow diagram illustrating a document image processing method, in accordance with one or more aspects of the present disclosure.

FIG. 5 depicts the coordinate system for horizontal lines of text in the image of a document, in accordance with one or more aspects of the present disclosure.

FIG. 6 depicts the geometric features of multiple fields in an image of a document, in accordance with one or more aspects of the present disclosure.

FIG. 7 depicts a network topology for assessing the confidence of a field type hypothesis in a document image, in accordance with one or more aspects of the present disclosure.

FIG. 8 depicts an example computer system which can perform any one or more of the methods described herein, in accordance with one or more aspects of the present disclosure.

### DETAILED DESCRIPTION

Embodiments for identification of text fields based on context using artificial intelligence, including convolutional neural networks, are described. One algorithm for identifying fields and corresponding field types in an image of a document is the heuristic approach. In the heuristic approach, a large number (e.g., hundreds) of images of documents, such as restaurant checks or receipts, for example, are taken and statistics are accumulated regarding what text (e.g., keywords) is used next to a particular field and where this text can be placed relative to the field (e.g., to the right, left, above, below). For example, the heuristic approach tracks d or words are typically located next to the field indicating the total purchase amount, what word or words are next to the field indicating applicable taxes, what word or words are written next to the field indicating the total payment on a credit card, etc. On the basis of these statistics, when processing an image of a new check, it can be determined which data detected on the document image corresponds to a particular field. The heuristic approach does not always work precisely, however,because if for some reason a check has been recognized with errors, namely in the word combinations “TOTAL TAX” and “TOTAL PAID” the words “tax” and “paid” were poorly recognized, the corresponding values might be miscategorized.

Another approach for field identification s the Name Entity Recognition (NER) method. In this approach, after the entire recognized text of the document image is received, it is divided into separate words that are fed into the input of a recurrent neural network. The network determines the probability that each word corresponds to a certain class, which, in the case of checks, is a particular field. The quality of the NER determination is usually measured based on found and missed words or symbols. But in searching for fields in a check, one is interested in the corresponding values of the fields as well. That is, after the text identifying the field is recognized, it is also necessary to extract the value of the field. In general, the NER approach works well, although not as well as some known specialized methods that extract specific fields using all the data specific for these fields, including geometry, context, and arithmetic rules.

In one embodiment, the field identification techniques described herein include making one or more hypotheses regarding a field type for a particular field in the image of a document (e.g., a check). For the initial hypotheses, a simple procedure for searching fields by regular expressions can be used. A regular expression search can be used to distinguish different types of data in the check, for example, to distinguish monetary amounts from phone numbers, but it will not help to distinguish other types of more similar data, (e.g., different types of monetary amounts such as total, change, payment on a bank card, applied discount, etc.). In addition to regular expressions, templates can be used to identify different fields on a check. The templates e,an store information about the structure of a particular vendor's check, including an expected field type associated with a location of the field on the check. A single field or entire rows of a template may be badly superimposed on a particular check, however, because of recognition errors or local differences of a particular check from he checks used in the training of the template. Thus, in both cases, the next step after making the one or more hypotheses assess the quality of the hypotheses for individual fields.

Described herein is a system and method for evaluation of the hypotheses for particular fields. Depending on the embodiment, if there are several hypotheses, the method can choose the best (i.e., most likely to be correct) hypothesis, or sort the multiple hypotheses by an assessment of quality. If there is only a single hypothesis, the method may estimate a confidence value of the hypothesis to indicate how likely it is that the chosen hypothesis for the field is correct. As a result of such an assessment, the method can provide a client with not only the results of a field search, but also an indication of the confidence in the results.

Embodiments of the present disclosure make such an assessment by using a set of machine learning models (e.g., neural networks) to effectively identify textual fields in an image. The set of machine learning models may be trained on a body of document images that form a training data set. The training data set includes examples of images of documents comprising one or more fields as a training input and one or more field type identifiers that correctly correspond to the one or more fields as a target output.

The terms “character,” “symbol,” “letter,” and “cluster” may be used interchangeably herein. A cluster may refer to an elementary indivisible graphic element (e.g., graphemes and ligatures), which are united by a common logical value. Further, the term “word” may refer to a sequence of symbols, and the term “sentence” may refer to a sequence of words.

Once trained, the set of machine learning models may be used for identification of text fields and to select the most confidential field type of a particular field. The use of machine learning models (e.g. convolutional neural networks) prevents the need for manual markup of keywords for a search of fields on a check, as the manual work is replaced by machine learning. The techniques described herein allow for a simple network topology, and the network is quickly trained on a relatively small dataset, compared to NER, for example. In addition, the method is easily applied to multiple use cases and the network can be trained using checks of one vendor, and then applied to checks of another vendor with high quality results. Furthermore, using a convolutional network makes it possible to reduce the number of errors in finding fields on the image of checks by approximately 5-30%.

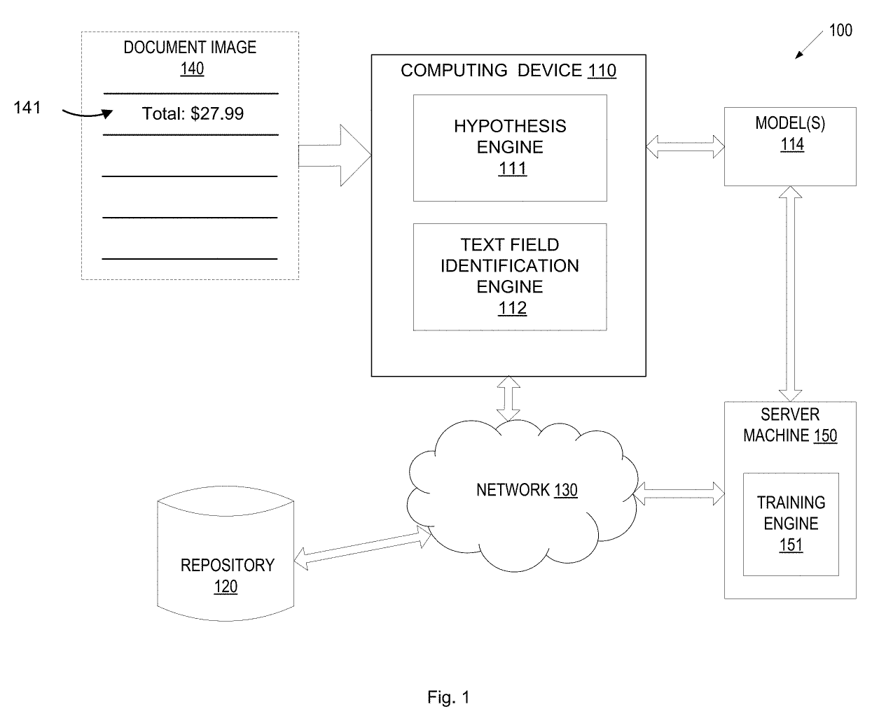

FIG. 1 depicts a high-level component diagram of an illustrative system architecture 100, in accordance with one or more aspects of the present disclosure. System architecture 100 includes a computing device 110, a repository 120, and a server machine 150 connected to a network 130. Network 130 may be a public network (e.g., the Internet), a private network (e.g., a local area network (LAN) or wide area network (WAN)), or a combination thereof.

The computing device 110 may perform field identification using artificial intelligence to effectively identify and categorize one or more fields in a document image 140. The identified fields may be identified by one or more words and may include one or more values. The identified words or values may each include one or more characters (e.g. clusters). In one embodiment, computing device 110 may be a desktop computer, a laptop computer, a smartphone, a tablet computer, a server, a scanner, or any suitable computing device capable of performing the techniques described herein. The document image 140 including one or more fields 141 may be received by the computing device 110. It should be noted that the document image 140 may include text printed or handwritten in any language.

The document image 140 may be received in any suitable manner. For example, the computing device 110 may receive a digital copy of the document image 140 by scanning the document or photographing the document. Additionally, in instances where the computing device 110 is a server, a client device connected to the server via the network 130 may upload a digital copy of the document image 140 to the server. In instances where the computing device 110 is a client device connected to a server via the network 130, the client device may download the document image 140 from the server.

The document image 140 may be used to train a set of machine learning models or may be a new document for which field identification is desired. Accordingly, in the preliminary stages of processing, the document image 140 can be prepared for training the set of machine learning models or subsequent identification. For instance, in the document image 140 field 141 may be manually or automatically selected, characters may be marked, text lines may be straightened, scaled and/or binarized. Straightening may be performed before training the set of machine learning models and/or before identification field 141 in the document image 140 to bring every line of text to a uniform height (e.g., 80 pixels).

In one embodiment, computing device 110 may include a hypothesis engine 111 and a text field identification engine 112. The hypothesis engine 111 and the text field identification engine 112 may each include instructions stored on one or more tangible, machine-readable storage media of the computing device 110 and executable by one or more processing devices of the computing device 110. In one embodiment, hypothesis engine 111 generates one or more initial hypotheses regarding the field type of field 141. For example, the initial hypotheses can be made using a simple procedure for searching fields by regular expressions, using templates to identify different fields on a check. In one embodiment, the text field identification engine 112 may use a set of trained machine learning models 114 that are trained and used to identify fields in the document image 140 and confirm or rebut the initial hypotheses. The text field identification engine 112 may also preprocess any received images, such as document image 140, prior to using the images for training of the set of machine learning models 114 and/or applying the set of trained machine learning models 114 to the images. In some instances, the set of trained machine learning models 114 may be part of the text field identification engine 112 or may be accessed on another machine (e.g., server machine 150) by the text field identification engine 112. Based on the output of the set of trained machine learning models 114, the text field identification engine 112 may obtain an assessment of a quality of one or more hypotheses for a field type of field 141 in the document image 140.

Server machine 150 may be a rackmount server, a router computer, a personal computer, a portable digital assistant, a mobile phone, a laptop computer, a tablet computer, a camera, a video camera, a netbook, a desktop computer, a media center, or any combination of the above. The server machine 150 may include a training engine 151. The set of machine learning models 114 may refer to model artifacts that are created by the training engine 151 using the training data that includes training inputs and corresponding target outputs (correct answers for respective training inputs). During training, patterns in the training data that map the training input to the target output (the answer to be predicted) can be found, and are subsequently used by the machine learning models 114 for future predictions. As described in more detail below, the set of machine learning models 114 may be composed of, e.g., a single level of linear or non-linear operations (e.g., a support vector machine [SVM]) or may be a deep network, i.e., a machine learning model that is composed of multiple levels of non-linear operations). Examples of deep networks are neural networks including convolutional neural networks, recurrent neural networks with one or more hidden layers, and fully connected neural networks.

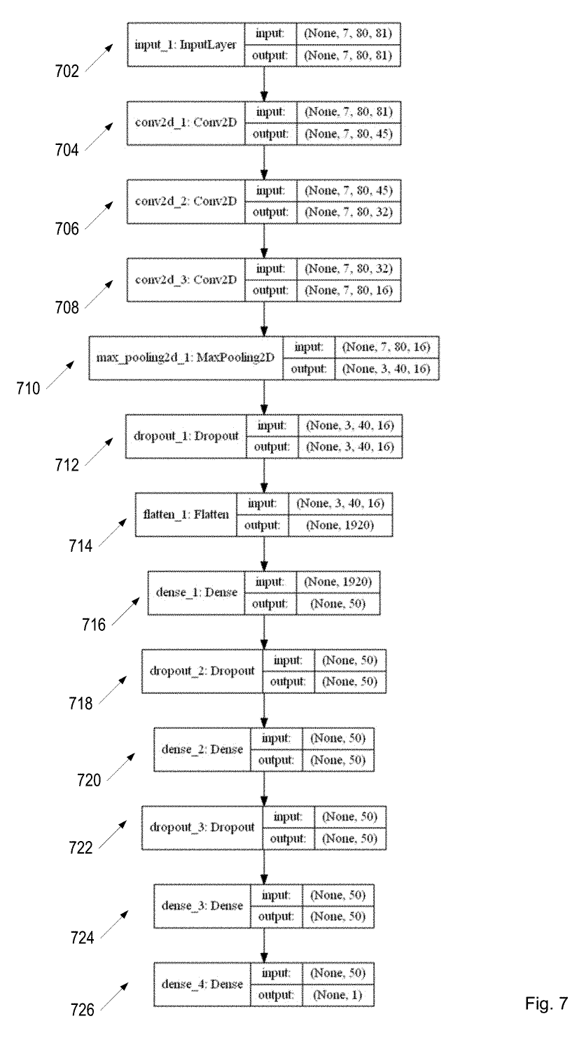

Convolutional neural networks include architectures that may provide efficient text field identification. Convolutional neural networks may include several convolutional layers and subsampling layers that apply filters to portions of the document image to detect certain features. That is, a convolutional neural network includes a convolution operation, which multiplies each image fragment by filters (e.g., matrices), element-by-element, and sums the results in a similar position in an output image (example architecture shown in FIG. 7).

As noted above, the set of machine learning models 114 may be trained to determine the most confidential field type of field 141 in the document image 140 using training data, as further described below. Once the set of machine learning models 114 are trained, the set of machine learning models 114 can be provided to text field identification engine 112 for analysis of new images of text. For example, the text field identification engine 112 may input the document image 140 being analyzed into the set of machine learning models 114. The text field identification engine 112 may obtain one or more outputs from the set of trained machine learning models 114. The output is an assessment of a quality of one or more hypotheses for a field type of field 141 (e.g., an indication of whether the hypotheses are correct).

The repository 120 is a persistent storage that is capable of storing document images 140 as well as data structures to tag, organize, and index the document images 140. Repository 120 may be hosted by one or more storage devices, such as main memory, magnetic or optical storage based disks, tapes or hard drives, NAS, SAN, and so forth. Although depicted as separate from the computing device 110, in an implementation, the repository 120 may be part of the computing device 110. In some implementations, repository 120 may be a network-attached file server, while in other embodiments, repository 120 may be some other type of persistent storage such as an object-oriented database, a relational database, and so forth, that may be hosted by a server machine or one or more different machines coupled to the via the network 130.

In one embodiment, text field identification engine 112 begins the process of identifying fields in document image 140 by making one or more hypotheses for a field type of field 141. To determine the one or more hypotheses, the text field identification engine 112 may perform a regular expression search to identify a type of data present in the field 141 or may apply a template to the document image 140 to determine an expected field type associated with a location of the field 141 in the document image 140. Sorting the hypotheses based on quality may be performed, for example, in cases where it is necessary to distinguish fields containing similar data on checks. As an example of similar data fields that may be distinguished on checks, the following may be present, for example.
1. Monetary amount: total, change, payment by credit card, discount
2. Monetary amounts within the framework of items (option 1) the price of the goods, discount, the price including discounts.
3. Monetary amounts within the framework of items (option 2): the unit price and the total value of the item.
4. Telephone/fax/telephone hotline.
5. Credit card number, discount card number, gift card number or digits with asterisks that are not card number.
6. Zip code and house number in American checks.
7. Date of the transaction on the check, the date by which you can return the goods, the end date of sonic action, the date of arrival/departure to the parking lot, etc.

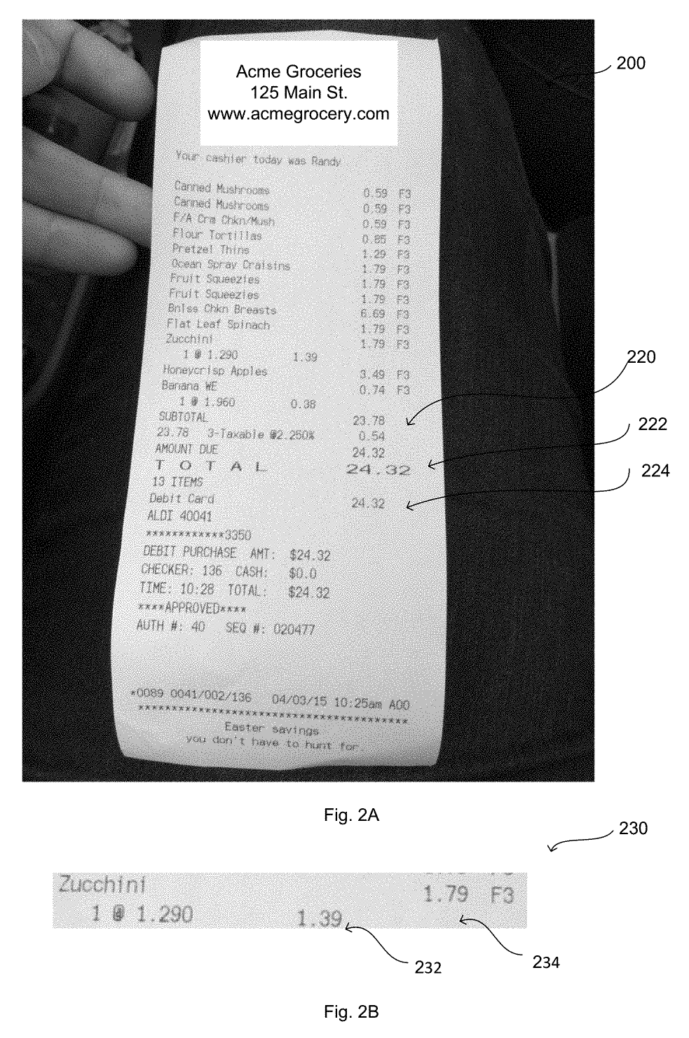

FIG. 2A illustrates an image of a check 200 on which there are similar data types (i.e., similar fields). For example, check 200 contains several monetary amounts for the following items (Subtotal 220, Total 222, Debit card 224) or several monetary amounts within one item (see FIG. 213 illustrating a fragment of check 200 corresponding to one of the items 230, where 232 is the price per unit of Zucchini, 234 is the total value of the Zucchini product). As described in more detail below, text field identification engine 112 makes it possible to distinguish these fields and the corresponding values from one another.

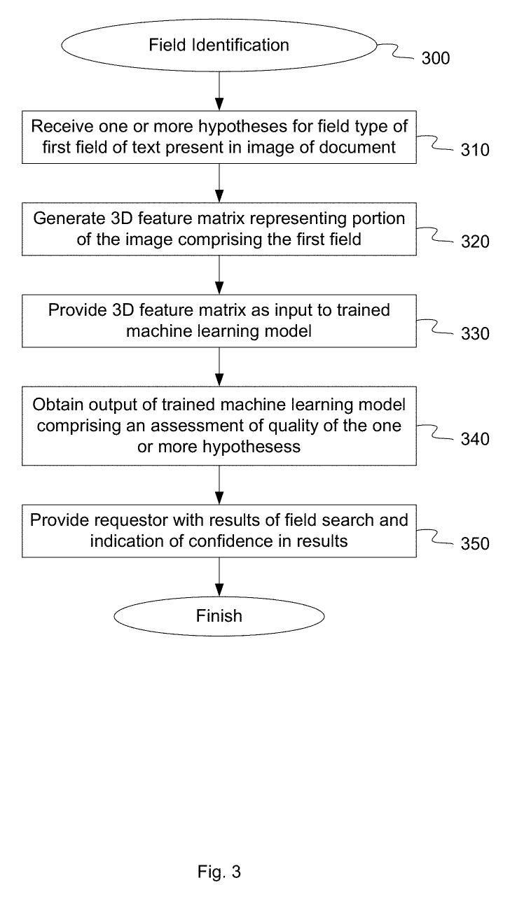

FIG. 3 is a flow diagram illustrating a field identification method, in accordance with one or more aspects of the present disclosure. The method 300 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 300 may be performed by computing device 110 including hypothesis engine 111 and text field identification engine 112, as shown in FIG. 1.

Referring to FIG. 3, at block 310, method 300 receives one or more hypotheses for a field type of a first field of text present in an image of a document. In one embodiment, text field identification engine 112 may receive a request to perform a field identification on an image of a document, such as document image 200. The request may be received from a user of computing device 110, from a user of a client device coupled to computing device 110 via network 130, or from some other requestor.

In one embodiment, the request includes one or more hypotheses generated by hypothesis engine 111 regarding a field type for one or more fields in the document image 140. The hypotheses may represent an initial guess or prediction of the field type made using computationally fast and cheap techniques. For example, for generation of the initial hypotheses, hypothesis engine 111 can use a simple procedure for searching fields by regular expressions. A regular expression search can be used to distinguish different types of data in the check, for example, to distinguish monetary amounts from phone numbers, but will not help to distinguish other types of more similar data, (e.g., different types of monetary amounts such as total, change, payment on a bank card, applied discount, etc.). In addition to regular expressions, hypothesis engine 111 can use templates to identify different fields on a check. The templates can store information about the structure of a particular vendor's check, including the expected location of each particular field type on the check. Text field identification engine 112 can store the received one or more hypotheses in repository 120.

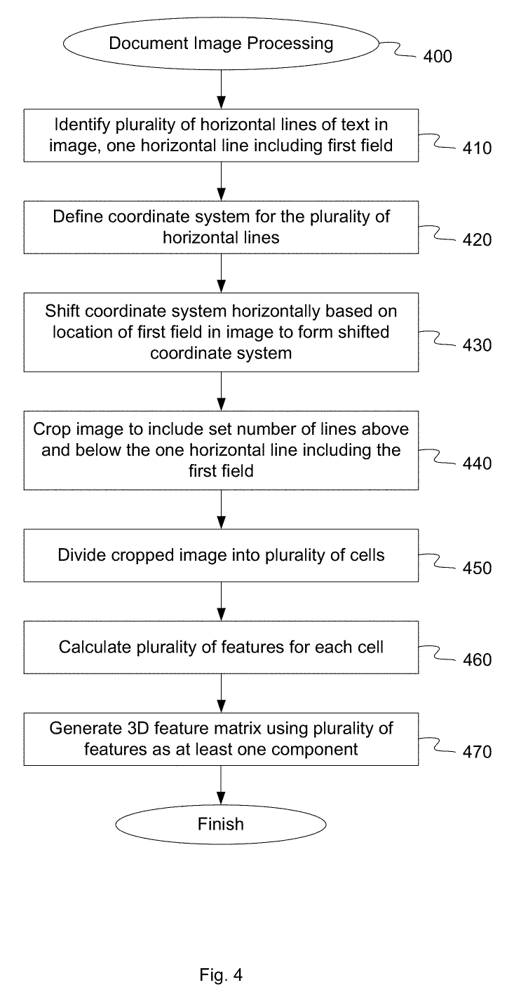

At block 320, method 300 generates a three dimensional feature matrix representing a portion of the image comprising the first field and an associated local context. In one embodiment, text field identification engine 112 performs a number of processing operations on the document image 200 to extract a number of features for input into machine learning models 114. For example, the first dimension of the matrix may be a height measurement representing a relative position along Y-axis (e.g., a specified line), the second dimension of the matrix may be a width measurement representing a relative position in the specified line along the X axis (e.g., a particular cell), and the third dimension of the matrix may be a feature vector representing values extracted from the X-Y location the document image 200 and arranged in a certain order. Trained machine learning modules 114 can use the three dimensional feature matrix representing a portion of the image comprising the first field and its local context to identify and classify a field type of any field of text present at that portion of the image. Additional details regarding feature detection,image processing and generation of the three dimensional feature matrix are provided below with respect to FIGS. 4-6.

At block 330, method 300 provides the three dimensional feature matrix as an input to one or more of trained machine learning models 114. In one embodiment, the set of machine learning models 114 may be composed of a single level of linear or non-linear operations, such as an SVM or deep network (i.e., a machine learning model that is composed of multiple levels of non-linear operations), such as a convolutional neural network. In one embodiment, the convolutional neural network is trained using a training data set formed from examples of images of documents comprising one or more fields as a training input and one or more field type identifiers that correctly correspond to the one or more fields as a target output. The training may result in an optimal topology of the network. In one embodiment, the layers of the network may include a first convolution layer with a filter window of 1×1. One cell of the feature matrix generated above (i.e., the feature values corresponding to a certain x and y position) can be read and input into approximately 20 neurons. In one embodiment, there may be approximately 100 features, the number of which is reduced to approximately 20 features at the output from the first convolution layer. There may be a further convolution layer inside each line with a filter window 1×10. Thus, the network can distribute (i.e., extract) information thin the line at the location. That is, if there is some feature, the network can determine not only whether it is in a particular ell or not, but whether it is in the neighboring cells as well. Thus, the network can obtain attributes that take into account a small local context. Finally, there v be a fully connected layer (e.g., a square convolution 3×3). The number of neurons in this layer can depends on the problem to be solved by the network.

At block 340, method 300 obtains an output of the trained machine learning model, wherein the output comprises an assessment of a quality of the one or more hypotheses. The assessment of the quality of the one or more hypotheses comprises at least one of an indication that a first hypothesis of the one or more hypotheses is a preferred hypothesis from a plurality of hypotheses or a confidence value associated with the one or more hypotheses. If it is desired to sort the hypotheses by quality (i.e., the scenario f distinguishing the type of monetary amount), then the output layer can have several neurons (e.g., one for each type of monetary amount). The output from each neuron can be a number that characterizes the assessment of quality that the data under consideration is related to a certain class (i.e., type of field). If simply a confidence that the data belongs to a particular field is desired (i.e., an indication of whether it is the type of field for a first field: yes or no), the output layer can include one neuron, which gives a number indicating a confidence that the data corresponds to the field. For different fields, the topology can vary slightly depending on the quantity and quality of the data available for training, but one example of the network topology for assessing the confidence of a field hypothesis in a check is illustrated in FIG. 7.

FIG. 7 depicts a network topology for assessing the confidence of a field type hypothesis in a document image, in accordance with one or more aspects of the present disclosure. In one embodiment, the network topology represents a convolutional neural network that is part of the set of machine learning models 114. The convolutional neural network includes a convolution operation, where each image position is multiplied by one or more filters (e.g., matrices of convolution), as described above, element-by-element, and the result is summed and recorded in a similar position of an output image. The convolutional neural network includes an input layer and several layers of convolution and subsampling. For example, the convolutional neural network may include a first layer 702 having a type of input layer, a second layer 704 having a type of convolutional layer, a third layer 706 having a type of convolutional layer, a fourth layer 708 having a type of convolutional layer, a fifth layer 710, having a type of max pooling layer, a sixth layer 712 having a type of dropout layer, a seventh layer 714 having a type of flatten layer, an eighth layer 716 having a type of desense layer, a ninth layer 718 having a type of dropout layer, a tenth layer 720 having a type of desense layer, an eleventh layer 722 having a type of dropout layer, a twelfth layer 724 having a type of desense layer, and a thirteenth layer having a type of desense layer.

Referring again to FIG. 3, at block 350, method 300 provides a requestor with results of the field search and an indication of confidence in the results.

FIG. 4 is a flow diagram illustrating a document image processing method, in accordance with one or more aspects of the present disclosure. The method 400 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 400 may be performed by text field identification engine 112, as shown in FIG. 1.

Referring to FIG. 4, at block 410, method 400 identifies a plurality of horizontal lines of text present in the image, wherein one of the plurality of horizontal lines includes the first field. In one embodiment, text field identification engine 112 optionally transforms the image to make all lines of text horizontal.

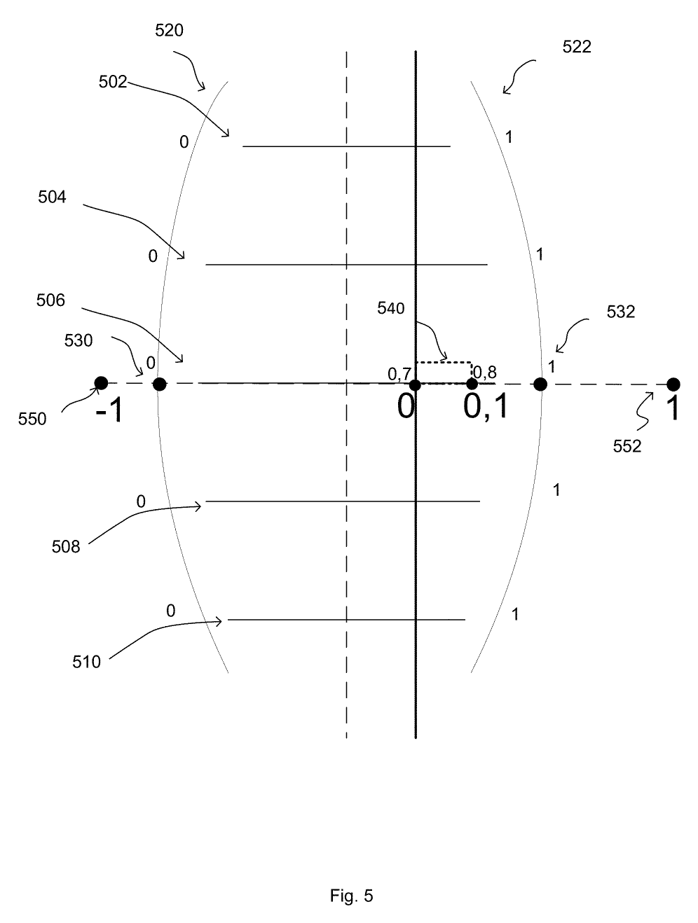

At block 420, method 400 defines a coordinate system for the plurality of horizontal lines. In one embodiment, to define the coordinate system, text field identification engine 112 identifies a left edge and a right edge of the document in the image, associates a first value with a first location at an intersection of the left edge and at least one of the plurality of horizontal lines, and associates a second value with a second location at an intersection of the right edge and the at least one of the plurality of horizontal lines. As illustrated in FIG. 5, for each line 502-510, text field identification engine 112 defines the coordinate system. The intersection of the left border of the check 520 with line 506 is denoted as 0 (530) and the intersection of the right border of the check 522 with line 506 is denoted as 1 (532). Thus, all words and characters that make up line 506 will be located between 0 and 1 in the defined corrdinate system.

At block 430, method 400 shifts the coordinate system horizontally based on a location of the first field in the image to form a shifted coordinate system, wherein the three dimensional feature matrix is based on the shifted coordinate system. In one embodiment, to shift the coordinate system, text field identification engine 112 shifts the first value to the location of the first field in the image. Text field identification engine 112 may shift the coordinate system horizontally so that the data that to be classified is in the middle of the corresponding coordinate system. As further shown in FIG. 5, the data 540 to be refined (i.e., for which a confidence of the hypothesis will be obtained) in the initial coordinate system of the corresponding me starts at the point with the coordinate 0.7 and ends at the point with the coordinate 0.8. Text field identification engine 112 transfers the defined coordinate system another coordinate system, for which the coordinate 0.7 will become 0, and the coordinate 0.8 will become 0.1. The new coordinate system can be expanded to an interval from −1 (550) to 1 (552). A similar shift is clone for all other lines (i.e. for all lines, the points with the coordinate 0.7 will become 0). Thus, the entire check will fit into a new coordinate system wherever the field of interest is located, while the field 540 itself will be at the center of the new coordinate system. Such a shift will allow for training machine learning models 114 with a simpler topology. In one embodiment, the three dimensional feature matrix is based on this shifted coordinate system.

At block 440, method 400 crops the image to form a cropped image comprising a set number of lines above and below the one of the plurality of horizontal lines that includes the first field. In one embodiment, text field identification engine 112 crop the image by limiting it to 3-5 lines above the data (line) of interest and the same number of lines below the data (line) of interest. This cropping is based on the assumption that the field type is affected only by the local context. In general, it is possible to send the entire image of the check to the network input, but usually information that is located far from the data of interest has little effect on the field type. In one embodiment, the network accepts a matrix of fixed-size attributes. Therefore, text field identification engine 112 can fix the number of lines (i.e., the height of the matrix). If the image is cropped to include 5 lines before and after the data of interest, then the height of the matrix of features submitted to the input of the network will be 11.

At block 450, method 400 divides the cropped image into a plurality of cells. In one embodiment, text field identification engine 112 splits the resulting rectangle into several parts vertically with an interval slightly less than the width of the symbol (e.g., 80-100 pieces). By doing so, the data is divided into cells. In one embodiment, the width of the feature matrix can also be of a fixed size. Since the width f the checks can be arbitrary, with a variable number of characters in the lines, text field identification engine 112 can split the entire interval from 1 to −1 into 80-100 equally sized parts.

At block 460, method 400 calculates a plurality of features for each of the plurality of cells, wherein the plurality of features comprises information related to graphic elements representing one or more characters present in a corresponding cell. In one embodiment, text field identification engine 112 uses the information obtained as a result of optical character recognition of the image of the check and features that are calculated from the image (e.g., the black area, the number of RLE strokes). The features that are calculated from the image are rather auxiliary and can be used to “level out” the identification errors. In general, the possible features can be organized into the following classes. Among these features, there are binary ones there is a letter (1) or not (0)), and real ones.

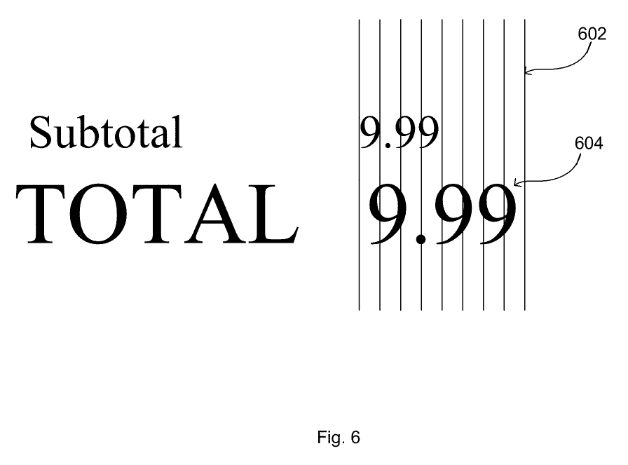

A first feature class includes information about a particular recognized symbol (i.e., whether this symbol is a specific Unicode, capital or lowercase letter, symbol class (letter or number), etc.). A second feature class includes a confidence in the character recognition. These features strongly affect the confidence of field identification. For example, it is possible that we are almost sure that we have found the field in the right place, but also we are sure that we have recognized this field with errors, so we cannot trust the field value, although it is in the right place of the image. A third feature class includes features that characterize the meaning of the words present on the check. Such features may include word embedding, presence in a specific dictionary, etc. These features also characterize the surrounding of the field, including all other words in the immediate surrounding. For example, the network can learn that if there is something about taxes and something about SUBTOTAL before data under consideration, then the data is probably the field of the total monetary amount, even if the word TOTAL itself was not recognized. Word embedding can be trained on a corpus of texts, or on the texts of checks. A fourth feature class includes geometric features that allow for restoration of the structure of the check. These attributes can be calculated from the image. Examples of geometric features can include counting the number of black pixels, number of RLE strokes, line height, etc. In addition, text field identification engine 112 can consider features related to the width of the symbols. In checks, some letters have a double size, i.e. occupy 2 monospaced cells. FIG. 6 illustrates data where field 602 includes single-width symbols, and field 604 includes doubled-sized symbols. Such wide letters often highlight in the checks the keywords (e.g., the word TOTAL). Even if the character was recognized incorrectly or not recognized at all, the information that this symbol is high or wide can be useful to understand that there is some important field nearby. In total, approximately 100 features for each cell can be calculated and stored for input into network.

At block 470, method 400 generates the three dimensional feature matrix using the plurality of features as at least one component of the three dimensional feature matrix. For example, the first dimension of the matrix may be a height measurement representing a relative position along a Y-axis (e.g., a specified line), the second dimension of the matrix may be a width measurement representing a relative position in a row along the X axis (e.g., a particular cell), and the third dimension of the matrix may be a feature representing feature values extracted from the X-Y location in the document image 200 and recorded in a certain order.

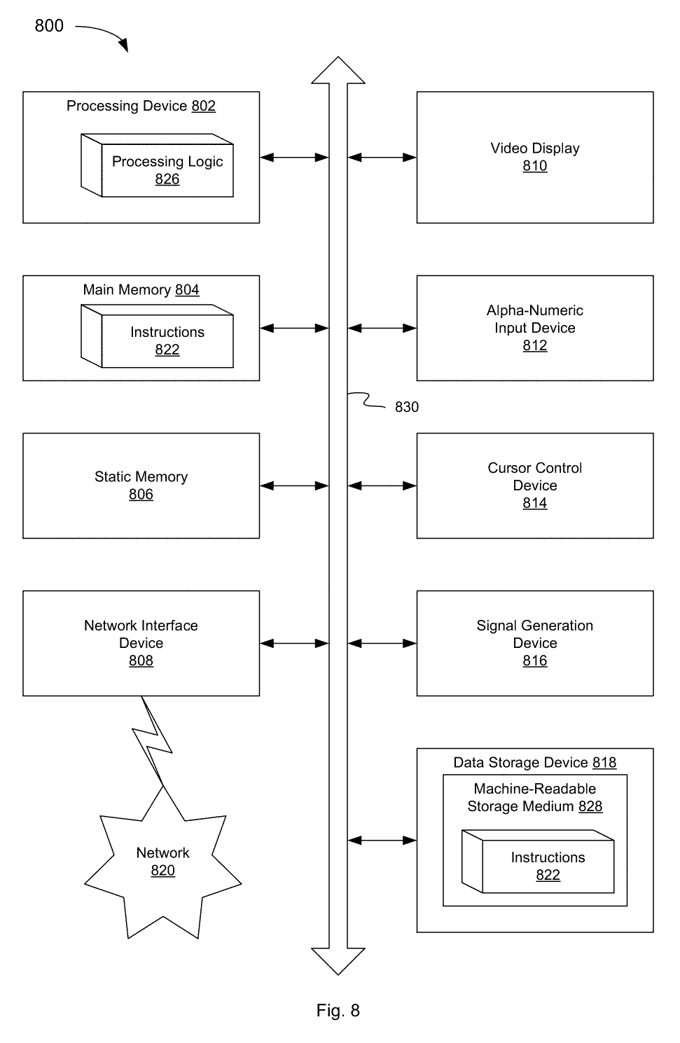

FIG. 8 depicts an example computer system 800 which can perform any one or more of the methods described herein, in accordance with one or more aspects of the present disclosure. In one example, computer system 800 may correspond to a computing device capable of executing text field identification engine 112 of FIG. 1. In another example, computer system 800 may correspond to a computing device capable of executing training engine 151 of FIG. 1. The computer system 800 may be connected (e.g., networked) to other computer systems in a LAN, an intranet, an extranet, or the Internet. The computer system 800 may operate in the capacity of a server in a client-server network environment. The computer system 800 may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 818, which communicate with each other via a bus 830.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions for performing the operations and steps discussed herein.

The computer system 800 may further include a network interface device 808. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker). In one illustrative example, the video display unit 810, the alphanumeric input device 812, and the cursor control device 814 may be combined into a single component or device (e.g., an LCD touch screen).

The data storage device 818 may include a computer-readable medium 828 on which the instructions 822 (e.g., implementing text field identification engine 112 or training engine 151) embodying any one or more of the methodologies or functions described herein is stored. The instructions 822 may also reside, completely or at least partially, within the main memory 804 and/or within the processing device 802 during execution thereof by the computer system 800, the main memory 804 and the processing device 802 also constituting computer-readable media. The instructions 822 may further be transmitted or received over a network via the network interface device 808.

While the computer-readable storage medium 828 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
receiving one or more hypotheses for a field type of a first field of text present in an image of a document;
generating, by a processing device, a three dimensional feature matrix representing a portion of the image comprising the first field;
providing the three dimensional feature matrix as an input to a trained machine learning model; and
obtaining an output of the trained machine learning model, wherein the output comprises an assessment of a quality of the one or more hypotheses.

2. The method of claim 1, wherein the one or more hypotheses are determined using regular expression search to identify a type of data present in the first field.

3. The method of claim 1, wherein the one or more hypotheses are determined using a template applied to the image to determine an expected field type associated with a location of the first field in the image.

4. The method of claim 1, further comprising:
identifying a plurality of horizontal lines of text present in the image, wherein one of the plurality of horizontal lines includes the first field;
defining a coordinate system for the plurality of horizontal lines; and
shifting the coordinate system horizontally based on a location of the first field in the image to form a shifted coordinate system.

5. The method of claim 4, wherein defining the coordinate system comprises:
identifying a left edge and a right edge of the document in the image;
associating a first value with a first location at an intersection of the left edge and at least one of the plurality of horizontal lines; and
associating a second value with a second location at an intersection of the right edge and the at least one of the plurality of horizontal lines;
wherein shifting the coordinate system horizontally comprises shifting the first value to the location of the first field in the image.

6. The method of claim 4, wherein the three dimensional feature matrix is based on the shifted coordinate system.

7. The method of claim 4, further comprising:
cropping the image to form a cropped image comprising a set number of lines above and below the one of the plurality of horizontal lines that includes the first field.

8. The method of claim 7, further comprising:
dividing the cropped image into a plurality of cells; and
calculating a plurality of features for each of the plurality of cells, wherein the plurality of features comprises at least one component of the three dimensional feature matrix.

9. The method of claim 8, wherein the plurality of features comprises information related to graphic elements representing one or more characters present in a corresponding cell.

10. The method of claim 1, wherein the trained machine learning model comprises a convolutional neural network.

11. The method of claim 1, wherein the assessment of the quality of the one or more hypotheses comprises at least one of an indication that a first hypothesis of the one or more hypotheses is a preferred hypothesis from a plurality of hypotheses or a confidence value associated with the one or more hypotheses.

12. The method of claim 1 wherein the trained machine learning model is trained using a training data set, the training data set comprising examples of images of documents comprising one or more fields as a training input and one or more field type identifiers that correctly correspond to the one or more fields as a target output.

13. A system comprising:
a memory device storing instructions;
a processing device coupled to the memory device, the processing device to execute the instructions to:
receive one or more hypotheses for a field type of a first field of text present in an image of a document;
generate a three dimensional feature matrix representing a portion of the image comprising the first field;
provide the three dimensional feature matrix as an input to a trained machine learning model; and
obtain an output of the trained machine learning model, wherein the output comprises an assessment of a quality of the one or more hypotheses.

14. The system of claim 13, wherein the processing device further to:
identify a plurality of horizontal lines of text present in the image, wherein one of the plurality of horizontal lines includes the first field;
define a coordinate system for the plurality of horizontal lines; and
shift the coordinate system horizontally based on a location of the first field in the image to form a shifted coordinate system, wherein the three dimensional feature matrix is based on the shifted coordinate system.

15. The system of claim 14, wherein the processing device further to:
crop the image to form a cropped image comprising a set number of lines above and below the one of the plurality of horizontal lines that includes the first field;
divide the cropped image into a plurality of cells; and
calculate a plurality of features for each of the plurality of cells, wherein the plurality of features comprises information related to graphic elements representing one or more characters present in a corresponding cell and comprises at least one component of the three dimensional feature matrix.

16. The system of claim 13, wherein the assessment of the quality of the one or more hypotheses comprises at least one of an indication that a first hypothesis of the one or more hypotheses is a preferred hypothesis from a plurality of hypotheses or a confidence value associated with the one or more hypotheses.

17. A non-transitory computer-readable storage medium storing instructions that, when executed by a processing device, cause the processing device to:
receive one or more hypotheses for a field type of a first field of text present in an image of a document;
generate a three dimensional feature matrix representing a portion of the image comprising the first field;
provide the three dimensional feature matrix as an input to a trained machine learning model; and
obtain an output of the trained machine learning model, wherein the output comprises an assessment of a quality of the one or more hypotheses.

18. The non-transitory computer-readable storage medium of claim 17, wherein the processing device further to:
identify a plurality of horizontal lines of text present in the image, wherein one of the plurality of horizontal lines includes the first field;
define a coordinate system for the plurality of horizontal lines; and
shift the coordinate system horizontally based on a location of the first field in the image to form a shifted coordinate system, wherein the three dimensional feature matrix is based on the shifted coordinate system.

19. The non-transitory computer-readable storage medium of claim 18, wherein the processing device further to:
crop the image to form a cropped image comprising a set number of lines above and below the one of the plurality of horizontal lines that includes the first field;
divide the cropped image into a plurality of cells; and
calculate a plurality of features for each of the plurality of cells, wherein the plurality of features comprises information related to graphic elements representing one or more characters present in a corresponding cell and comprises at least one component of the three dimensional feature matrix.

20. The non-transitory computer-readable storage medium of claim 17, wherein the assessment of the quality of the one or more hypotheses comprises at least one of an indication that a first hypothesis of the one or more hypotheses is a preferred hypothesis from a plurality of hypotheses or a confidence value associated with the one or more hypotheses.
